(19) United States
(12) Patent Application Publication
(10) Pub. No.: US 2022/0162482 A1
(43) Pub. Date: May 26, 2022

(54) SILICONE PRESSURE SENSITIVE ADHESIVE COMPOSITION AND PREPARATION AND USE THEREOF IN PROTECTIVE FILMS FOR ULTRASONIC FINGERPRINT SENSORS

(71) Applicant: Dow Silicones Corporation, Midland, MI (US)

(72) Inventors: Qing Cao, Shanghai (CN); Yan Zhou, Shanghai (CN); Bochi Xu, Shanghai (CN)

(21) Appl. No.: 17/601,558

(22) PCT Filed: Jun. 13, 2019
(86) PCT No.: PCT/CN2019/091024

§ 371 Date: Oct. 5, 2021

(51) Int. Cl. C09J 7/38; C09J 7/25; C09J 7/29; C09J 11/06; B32B 7/12; B32B 27/08; B32B 27/36; B32B 17/10; G06V 40/13

(52) U.S. Cl. CPC C09J 7/38; B32B 2457/00; C09J 7/255; C09J 7/25; C09J 7/29; C09J 11/06; B32B 7/12; B32B 27/08; B32B 27/36; B32B 27/365; B32B 17/10; G06V 40/1306; C09J 2483/00; C09J 2433/00; C09J 2469/006; C09J 2467/006; C09J 2301/1242; C09J 7/385

(57) ABSTRACT

A silicone pressure sensitive adhesive composition containing: (A) a polydiorganosiloxane gum having a number average molecular weight≥500,000 g/mol, where the polydiorganosiloxane gum is terminated with an aliphatically unsaturated group; (B) a polydiorganosiloxane polymer having a number average molecular weight≤100,000 g/mol and an aliphatically unsaturated group content of >0.13 weight %; where starting materials (A) and (B) are present in a weight ratio (B)/(A) of 0.4 to 1.6; (C) a polyorganosilicate resin having a number average molecular weight<4,000 g/mol, where starting materials (A), (B) and (C) are present in a weight ratio (C)/(B+A) of 1.4 to 2; (D) a polyorganohydrogensiloxane; where starting materials (A), (B), and (D) are present in amounts sufficient to provide a molar ratio of silicon bonded hydrogen atoms/silicon bonded aliphatically unsaturated groups (SiH/Vi ratio) of 4 to 30 in the composition; (E) a hydrosilylation reaction catalyst; (F) an anchorage additive; and (G) a solvent. It is suitable for use in protective films for ultrasonic fingerprint sensors in display devices.

### CROSS REFERENCE TO RELATED APPLICATIONS

None.

### TECHNICAL FIELD

A silicone pressure sensitive adhesive composition is curable to form a silicone pressure sensitive adhesive, which is suitable for use in protective films for ultrasonic fingerprint sensors in display devices.

### BACKGROUND

In an ultrasonic sensor system, an ultrasonic transmitter may be used to send an ultrasonic wave through an ultrasonically transmissive medium and towards an object to be detected. The transmitter may be operatively coupled with an ultrasonic sensor configured to detect portions of the ultrasonic wave that are reflected from the object. For example, in ultrasonic fingerprint sensors, an ultrasonic pulse may be produced by starting and stopping the transmitter during a short time interval. At each material interface encountered by the ultrasonic pulse, a portion of the ultrasonic pulse is reflected.

In the context of an ultrasonic fingerprint sensor, the ultrasonic wave may travel through a protective film over which a person's finger may be placed to obtain a fingerprint image. After passing through the protective film, some portions of the ultrasonic wave encounter skin that is in contact with the protective film (or surface overlying the protective film), e.g., fingerprint ridges, while other portions of the ultrasonic wave encounter air, e.g., valleys between adjacent ridges of a fingerprint, and may be reflected with different intensities back towards the ultrasonic sensor. The reflected signals associated with the finger may be processed and converted to a digital value representing the signal strength of the reflected signal. When multiple such reflected signals are collected over a distributed area, the digital values of such signals may be used to produce a graphical display of the signal strength over the distributed area, for example by converting the digital values to an image, thereby producing an image of the fingerprint. Thus, an ultrasonic sensor system may be used as a fingerprint imager, and such ultrasonic sensor systems can be incorporated as ultrasonic fingerprint sensors to authenticate a user in various display devices such as mobile telephones, mobile television receivers, wireless devices, smartphones, personal data assistants, wireless electronic mail receivers, hand-held or portable computers, netbooks, notebooks, smartbooks, tablets, global positioning system receivers/navigators, cameras, digital media players, camcorders, game consoles, and electronic reading devices.

Ultrasonic fingerprint sensors have advantages over previously used optical fingerprint identification technology. Stronger signal penetration capability and better stain (water or sweat on fingerprint) tolerance may make ultrasonic fingerprint sensors more reliable in fingerprint identification than optical fingerprint sensors.

### SUMMARY

A silicone pressure sensitive adhesive composition and method for its preparation are disclosed. The silicone pressure sensitive adhesive composition cures to form a silicone pressure sensitive adhesive suitable for use with ultrasonic fingerprint identification technology. A protective film containing the silicone pressure sensitive adhesive and use in an ultrasonic fingerprint sensor are also disclosed.

### BRIEF DESCRIPTION OF THE DRAWINGS

FIG. 1 shows a partial cross section of a protective film 100 for an ultrasonic fingerprint sensor.

Reference Numerals

| | |
|---|---|
| 101 | Second Polymeric Substrate |
| 102 | Acrylic PSA |
| 103 | First Polymeric Substrate |
| 104 | Si-PSA |
| 105 | Anti-Fingerprint Coating |
| 106 | Cover Glass |
| 107 | Ultrasound Transmitter |

### DETAILED DESCRIPTION

The silicone pressure sensitive adhesive composition (Si-PSA composition) described above comprises:

(A) a polydiorganosiloxane gum having a number average molecular weight≥500,000 g/mol, where the polydiorganosiloxane gum is terminated with an aliphatically unsaturated group;

(B) a polydiorganosiloxane polymer having a number average molecular weight≤100,000 g/mol and an aliphatically unsaturated group content of >0.13 weight %;

where starting materials (A) and (B) are present in a weight ratio (B)/(A) of 0.4 to 1.6 (Polymer/Gum ratio);

(C) a polyorganosilicate resin having a number average molecular weight<4,000 g/mol, where starting materials (A), (B) and (C) are present in a weight ratio (C)/(B+A) of 1.4 to 2 (Resin/(Polymer+Gum) ratio);

(D) a polyorganohydrogensiloxane;

where starting materials (A), (B), and (D) are present in amounts sufficient to provide a molar ratio of silicon bonded hydrogen atoms/silicon bonded aliphatically unsaturated groups of 4 to 30 (SiH/Vi ratio) in the Si-PSA composition;

(E) a hydrosilylation reaction catalyst;

(F) an anchorage additive; and

(G) a solvent.

### (A) Polydiorganosiloxane Gum

The Si-PSA composition comprises (A) a polydiorganosiloxane gum having a number average molecular weight≥500,000 g/mol, where the polydiorganosiloxane gum is terminated with an aliphatically unsaturated group. The polydiorganosiloxane gum may have unit formula (A-1): (R^{M}₂R^{U}SiO_{1/2})₂(R^{M}₂SiO_{2/2})ₐ, where each R^{M} is an independently selected monovalent hydrocarbon group of 1 to 30 carbon atoms that is free of aliphatic unsaturation; each R^{U} is an independently selected monovalent aliphatically unsaturated hydrocarbon group of 2 to 30 carbon atoms; and subscript a has a value sufficient to give the polydiorganosiloxane gum a number average molecular weight≥500,000 g/mol, alternatively 500,000 g/mol to 1,000,000 g/mol.

In unit formula (A-1), each R^{M} is an independently selected monovalent hydrocarbon group of 1 to 30 carbon atoms that is free of aliphatic unsaturation. Alternatively, each R^{M} may have 1 to 12 carbon atoms, and alternatively 1 to 6 carbon atoms. Suitable monovalent hydrocarbon groups for R^{M} are exemplified by alkyl groups and aromatic groups such as aryl groups and aralkyl groups. “Alkyl” means a cyclic, branched, or unbranched, saturated monovalent hydrocarbon group. “Aryl” means a cyclic, fully unsaturated, hydrocarbon group. Aryl is exemplified by, but not limited to, cyclopentadienyl, phenyl, anthracenyl, and naphthyl. Monocyclic aryl groups may have 5 to 9 carbon atoms, alternatively 6 to 7 carbon atoms, and alternatively 5 to 6 carbon atoms. Polycyclic aryl groups may have 10 to 17 carbon atoms, alternatively 10 to 14 carbon atoms, and alternatively 12 to 14 carbon atoms. “Aralkyl” means an alkyl group having a pendant and/or terminal aryl group or an aryl group having a pendant alkyl group. Exemplary aralkyl groups include tolyl, xylyl, benzyl, phenylethyl, phenyl propyl, and phenyl butyl. Suitable groups for R^{M} are exemplified by linear and branched alkyl groups such as methyl, ethyl, propyl (e.g., iso-propyl and/or n-propyl), butyl (e.g., isobutyl, n-butyl, tert-butyl, and/or sec-butyl), pentyl (e.g., isopentyl, neopentyl, and/or tert-pentyl), hexyl, heptyl, octyl, nonyl, and decyl, and branched alkyl groups of 6 or more carbon atoms; cyclic alkyl groups such as cyclopentyl and cyclohexyl; aryl groups such as phenyl and naphthyl, and aralkyl groups such as tolyl, xylyl, benzyl, and phenethyl. Alternatively, each R^{M} may be independently selected from the group consisting of alkyl and aryl. Alternatively, each R^{M} may be independently selected from methyl and phenyl. Alternatively, each R^{M} may be alkyl. Alternatively, each R^{M} may be methyl.

In unit formula (A-1), each R^{U} is an independently selected monovalent aliphatically unsaturated hydrocarbon group of 2 to 30 carbon atoms. Alternatively, each R^{U} may have 2 to 12 carbon atoms, and alternatively 2 to 6 carbon atoms. Suitable monovalent aliphatically unsaturated hydrocarbon groups include alkenyl groups and alkynyl groups. “Alkenyl” means a branched or unbranched, monovalent hydrocarbon group having one or more carbon-carbon double bonds. Suitable alkenyl groups are exemplified by vinyl; allyl; propenyl (e.g., isopropenyl, and/or n-propenyl); and butenyl, pentenyl, hexenyl, and heptenyl, (including branched and linear isomers of 4 to 7 carbon atoms); and cyclohexenyl. “Alkynyl” means a branched or unbranched, monovalent hydrocarbon group having one or more carbon-carbon triple bonds. Suitable alkynyl groups are exemplified by ethynyl, propynyl, and butynyl (including branched and linear isomers of 2 to 4 carbon atoms). Alternatively, each R^{U} may be alkenyl, such as vinyl, allyl, or hexenyl.

Polydiorganosiloxane gums are known in the art and may be prepared by methods such as hydrolysis and condensation of the corresponding organohalosilanes or equilibration of cyclic polydiorganosiloxanes. Examples of suitable polydiorganosiloxane gums for use in the Si-PSA composition are exemplified by:
i) dimethylvinylsiloxy-terminated polydimethylsiloxane,
ii) dimethylvinylsiloxy-terminated poly(dimethylsiloxane/methylphenyl)siloxane,
iii) dimethylvinylsiloxy-terminated poly(dimethylsiloxane/diphenyl)siloxane,
iv) phenyl,methyl,vinyl-siloxy-terminated polydimethylsiloxane,
v) dimethylhexenylsiloxy-terminated polydimethylsiloxane,
vi) dimethylhexenyl-siloxy terminated poly(dimethylsiloxane/methylphenyl)siloxane,
vii) dimethylvinylsiloxy-terminated poly(dimethylsiloxane/diphenyl)siloxane,
viii) a combination of two or more of i) to vii).

The Si-PSA composition comprises the polydiorganosiloxane gum and the polydiorganosiloxane polymer in a weight ratio (B)/(A) of 0.4 to 1.6, which is the Polymer/Gum ratio. Alternatively, the Si-PSA composition may contain the polydiorganosiloxane gum at 14 weight parts to 22 weight parts, per 100 weight parts of starting materials (A), (B), and (C).

### (B) Polydiorganosiloxane Polymer

The Si-PSA composition further comprises (B) a polydiorganosiloxane polymer having a number average molecular weight≤100,000 g/mol and an aliphatically unsaturated group content of >0.13 weight %. The polydiorganosiloxane polymer may have unit formula (B-1): (R^{M}₃SiO_{1/2})_{b}(R^{M}₂R^{U}SiO_{1/2})_{c}(R^{M}₂SiO_{2/2})_{d}(R^{M}R^{U}SiO_{2/2})ₑ, where R^{M} and R^{U} are as described above; subscript b is 0, 1, or 2; subscript c is 0, 1, or 2, with the proviso that a quantity (b+c)=2; subscript d>0, subscript e≥0, with the proviso that a quantity (b+c+d+e) has a value sufficient to give the polydiorganosiloxane polymer a number average molecular weight≤100,000 g/mol, alternatively 10,000 to 75,000 g/mol.

Methods of preparing polydiorganosiloxane polymers such as hydrolysis and condensation of the corresponding organohalosilanes or equilibration of cyclic polydiorganosiloxanes, are well known in the art. Examples of polydiorganosiloxane polymers suitable for use in the Si-PSA composition include:
i) dimethylvinylsiloxy-terminated polydimethylsiloxane,
ii) dimethylvinylsiloxy-terminated poly(dimethylsiloxane/methylvinyl)siloxane,
iii) dimethylvinylsiloxy-terminated polymethylvinylsiloxane,
iv) trimethylsiloxy-terminated poly(dimethylsiloxane/methylvinyl)siloxane,
v) trimethylsiloxy-terminated polymethylvinylsiloxane,
vi) dimethylvinylsiloxy-terminated poly(dimethylsiloxane/methylvinyl)siloxane,
vii) dimethylvinylsiloxy-terminated poly(dimethylsiloxane/methylphenyl)siloxane,
viii) dimethylvinylsiloxy-terminated poly(dimethylsiloxane/diphenyl)siloxane,
ix) phenyl,methyl,vinyl-siloxy-terminated polydimethylsiloxane,
x) dimethylhexenylsiloxy-terminated polydimethylsiloxane,
xi) dimethylhexenylsiloxy-terminated poly(dimethylsiloxane/methylhexenyl)siloxane,
xii) dimethyl hexenylsiloxy-terminated polymethylhexenylsiloxane,
xiii) trimethylsiloxy-terminated poly(dimethylsiloxane/methylhexenyl)siloxane,
xiv) trimethylsiloxy-terminated polymethylhexenylsiloxane
xv) dimethyl hexenyl-siloxy terminated poly(dimethylsiloxane/methyl hexenyl)siloxane,
xvi) dimethylvinylsiloxy-terminated poly(dimethylsiloxane/methylhexenyl)siloxane, and
xvii) a combination of two or more of i) to xvi).

The Si-PSA composition may comprise the polydiorganosiloxane polymer at 13 weight parts to 23 weight parts, per 100 weight parts of starting materials (A), (B), and (C) combined.

### (C) Polyorganosilicate Resin

The Si-PSA composition further comprises (C) a polyorganosilicate resin, which comprises monofunctional units (“M” units) of formula R^{P}₃SiO_{1/2} and tetrafunctional silicate units (“Q” units) of formula SiO_{4/2}, where each R^{P} is selected from R^{M} and R^{U} as described above. Alternatively, in the polyorganosilicate resin, each R^{P} may be R^{M}. Alternatively, at least one-third, alternatively at least two thirds of the R^{P} groups are methyl groups. Alternatively, the M units may be exemplified by (Me₃SiO_{1/2}), (Me₂PhSiO_{1/2}), and (Me₂ViSiO_{1/2}). The polyorganosilicate resin is soluble in solvents such as those described above, exemplified by liquid hydrocarbons, such as benzene, toluene, xylene, and heptane, or in liquid organosilicon compounds such as low viscosity linear and cyclic polydiorganosiloxanes.

When prepared, the polyorganosilicate resin comprises the M and Q units described above, and the polyorganosiloxane further comprises units with silicon bonded hydroxyl groups and may comprise neopentamer of formula Si(OSiR^{M}₃)₄, where R^{M} is as described above, e.g., the neopentamer may be tetrakis(trimethylsiloxy)silane. ²⁹Si NMR spectroscopy may be used to measure hydroxyl content and molar ratio of M and Q units, where said ratio is expressed as {M(resin)}/{Q(resin)}, excluding M and Q units from the neopentamer. M:Q ratio represents the molar ratio of the total number of triorganosiloxy groups (M units) of the resinous portion of the polyorganosilicate resin to the total number of silicate groups (Q units) in the resinous portion. M:Q ratio may be 0.5:1 to 1.5:1.

The Mn of the polyorganosilicate resin depends on various factors including the types of hydrocarbon groups represented by R^{P} that are present. The Mn of the polyorganosilicate resin refers to the number average molecular weight measured using GPC, when the peak representing the neopentamer is excluded from the measurement. The Mn of the polyorganosilicate resin is <4,000 g/mol, alternatively 2,500 g/mol to <4,000 g/mol, and alternatively 2,700 g/mol to 2,900 g/mol. A suitable GPC test method for measuring Mn is disclosed in U.S. Pat. No. 9,593,209, Reference Example 1 at col. 31.

U.S. Pat. No. 8,580,073 at col. 3, line 5 to col. 4, line 31, and U.S. Patent Publication 2016/0376482 at paragraphs [0023] to [0026] are hereby incorporated by reference for disclosing MQ resins, which are suitable polyorganosilicate resins for use in the pressure sensitive adhesive composition described herein. The polyorganosilicate resin can be prepared by any suitable method, such as cohydrolysis of the corresponding silanes or by silica hydrosol capping methods. The polyorganosilicate resin may be prepared by silica hydrosol capping processes such as those disclosed in U.S. Pat. No. 2,676,182 to Daudt, et al.; U.S. Pat. No. 4,611,042 to Rivers-Farrell et al.; and U.S. Pat. No. 4,774,310 to Butler, et al. The method of Daudt, et al. described above involves reacting a silica hydrosol under acidic conditions with a hydrolyzable triorganosilane such as trimethylchlorosilane, a siloxane such as hexamethyldisiloxane, or mixtures thereof, and recovering a copolymer having M-units and Q-units. The resulting copolymers generally contain from 2 to 5 percent by weight of hydroxyl groups.

The intermediates used to prepare the polyorganosilicate resin may be triorganosilanes and silanes with four hydrolyzable substituents or alkali metal silicates. The triorganosilanes may have formula R^{M}₃SiX¹, where R^{M} is as described above and X¹ represents a hydrolyzable substituent such as halogen, alkoxy, acyloxy, hydroxyl, oximo, or ketoximo; alternatively, halogen, alkoxy or hydroxyl. Silanes with four hydrolyzable substituents may have formula SiX²₄, where each X² is halogen, alkoxy or hydroxyl. Suitable alkali metal silicates include sodium silicate.

The polyorganosilicate resin prepared as described above typically contain silicon bonded hydroxyl groups, i.e., of formulae, HOSi_{3/2} and/or HOR^{M}₂SiO_{1/2}. The polyorganosilicate resin may comprise up to 2% of silicon bonded hydroxyl groups, as measured by FTIR spectroscopy. For certain applications, it may desirable for the amount of silicon bonded hydroxyl groups to be below 0.7%, alternatively below 0.3%, alternatively less than 1%, and alternatively 0.3% to 0.8%. Silicon bonded hydroxyl groups formed during preparation of the polyorganosilicate resin can be converted to trihydrocarbon siloxane groups or to a different hydrolyzable group by reacting the silicone resin with a silane, disiloxane, or disilazane containing the appropriate terminal group. Silanes containing hydrolyzable groups may be added in molar excess of the quantity required to react with the silicon bonded hydroxyl groups on the polyorganosilicate resin.

Alternatively, the polyorganosilicate resin may further comprises 2% or less, alternatively 0.7% or less, and alternatively 0.3% or less, and alternatively 0.3% to 0.8% of units represented by formula XSiO_{3/2} and/or XR^{M}₂SiO_{1/2} where R^{M} is as described above, and X represents a hydrolyzable substituent, as described above for X¹. The concentration of silanol groups present in the polyorganosiloxane may be determined using FTIR spectroscopy.

Alternatively, the polyorganosilicate resin may have terminal aliphatically unsaturated groups. The polyorganosilicate resin having terminal aliphatically unsaturated groups may be prepared by reacting the product of Daudt, et al. with an unsaturated organic group-containing endblocking agent and an endblocking agent free of aliphatic unsaturation, in an amount sufficient to provide from 3 to 30 mole percent of unsaturated organic groups in the final product. Examples of endblocking agents include, but are not limited to, silazanes, siloxanes, and silanes. Suitable endblocking agents are known in the art and exemplified in U.S. Pat. Nos. 4,584,355; 4,591,622; and 4,585,836. A single endblocking agent or a mixture of such agents may be used to prepare such resin.

Alternatively, the polyorganosilicate resin may comprise unit formula (C-1): (R^{M}₃SiO_{1/2})ₘ(R^{M}₂R^{U}SiO_{1/2})ₙ(SiO_{4/2})ₒ, where R^{M} and R^{U} are as described above and subscripts m, n and o have average values such that m>0, n≥0, o>1, with the proviso that a quantity (m+n+o) has a value sufficient to provide the polyorganosilicate resin with the Mn described above. Alternatively, the polyorganosilicate resin comprises unit formula (C-2): (R^{M}₃SiO_{1/2})_{z}(SiO_{4/2})ₒ, where R^{M} and subscript o are as described above, and subscript z>4.

The Si-PSA composition comprises starting materials (A), (B) and (C) in a weight ratio (C)/(B+A) of 1.4 to 2.0, which is referred to as the Resin/(Polymer+Gum) ratio. Alternatively, the polyorganosilicate resin may be present at 60 weight parts to 66 weight parts, per 100 weight parts of starting materials (A), (B), and (C) combined.

### (D) Polyorganohydrogensiloxane

The Si-PSA composition described above further comprises (D) a polyorganohydrogensiloxane. The polyorganohydrogensiloxane may act as a crosslinker and has an average, per molecule, of at least 2 silicon bonded hydrogen atoms. Alternatively, the polyorganohydrogensiloxane may have at least 3 silicon bonded hydrogen atoms per molecule. The silicon-bonded hydrogen atoms may be terminal, pendant, or in both terminal and pendant locations in the polyorganohydrogensiloxane. The polyorganohydrogensiloxane may comprise any of the following siloxy units including silicon-bonded hydrogen atoms, optionally in combination with siloxy units which do not include any silicon-bonded hydrogen atoms: (R⁵₂HSiO_{1/2}), (R⁵H₂SiO_{1/2}), (H₃SiO_{1/2}), (R⁵HSiO_{2/2}), (H₂SiO_{2/2}), and/or (HSiO_{3/2}), where each R⁵ is independently a monovalent hydrocarbon group or a monovalent halogenated hydrocarbon group.

Each R⁵ is an independently selected monovalent hydrocarbon group or monovalent halogenated hydrocarbon group, as introduced above, and may be linear, branched, cyclic, or combinations thereof. Cyclic hydrocarbon groups encompass aryl groups as well as saturated or non-conjugated cyclic groups. Aryl groups may be monocyclic or polycyclic. Linear and branched hydrocarbon groups may independently be saturated or unsaturated. Suitable monovalent hydrocarbon groups may be exemplified by alkyl, alkenyl groups, alkynyl groups, aryl groups, and aralkyl groups, as described above for R^{M} and R^{U}. Suitable monovalent halogenated hydrocarbon groups are exemplified by halogenated alkyl groups such as 3-chloropropyl, 2-bromoethyl, fluoromethyl, 2-fluoropropyl, and 3,3,3-trifluoropropyl, 4,4,4-trifluorobutyl, 4,4,4,3,3-pentafluorobutyl, 5,5,5,4,4,3,3-heptafluoropentyl, 6,6,6,5,5,4,4,3,3-nonafluorohexyl, and 8,8,8,7,7-pentafluorooctyl, 2,2-difluorocyclopropyl, 2,3-difluorocyclobutyl, 3,4-difluorocyclohexyl, and 3,4-difluoro-5-methylcycloheptyl, chloromethyl, 2-dichlorocyclopropyl, and 2,3-dichlorocyclopentyl. Halogenated aryl groups for R⁵ are exemplified by, but not limited to, chlorobenzyl and fluorobenzyl. Alternatively, each R⁵ may be an independently selected monovalent hydrocarbon group.

Alternatively, the polyorganohydrogensiloxane may have the average formula (D-1): (R^{M}₃SiO_{1/2})ᵣ(R^{M}₂HSiO_{1/2})ₛ(R^{M}₂SiO_{2/2})ₜ(R^{M}HSiO_{2/2})ᵤ, where R^{M} is as described above; subscript r is 0, 1, or 2; subscript s is 0, 1, or 2, with the proviso that a quantity (r+s)=2; subscript t≥0, subscript u>0, with the proviso that a quantity (s+u)>2. Alternatively, subscript u≥2, alternatively subscript u is 2 to 500, alternatively 2 to 200, and alternatively 2 to 100.

Methods of preparing polyorganohydrogensiloxanes, such as hydrolysis and condensation of organohalosilanes, are well known in the art. Suitable polyorganohydrogensiloxanes are exemplified by:
i) trimethylsiloxy-terminated poly(dimethyl/methyl hydrogen)siloxane,
ii) trimethylsiloxy-terminated polymethylhydrogensiloxane,
iii) dimethylhydrogensiloxy-terminated poly(dimethyl/methylhydrogen)siloxane,
iv) dimethylhydrogensiloxy-terminated polymethylhydrogensiloxane, and
v) a combination of two or more of i) to iv).

Starting materials (A), (B), and (D) are present in amounts sufficient to provide a molar ratio of silicon bonded hydrogen atoms/silicon bonded aliphatically unsaturated groups of 4 to 30 (referred to as the SiH/Vi ratio) in the Si-PSA composition. Alternatively, the Si-PSA composition may comprise the polyorganohydrogensiloxane at 0.7 weight parts to 3 weight parts, per 100 weight parts of starting materials (A), (B), and (C) combined.

### (E) Hydrosilylation Reaction Catalyst

The Si-PSA composition further comprises (E) a hydrosilylation reaction catalyst. Hydrosilylation reaction catalysts are known in the art and are commercially available. Hydrosilylation reaction catalysts include platinum group metal catalysts. Such hydrosilylation reaction catalysts can be a metal selected from platinum, rhodium, ruthenium, palladium, osmium, and iridium. Alternatively, the hydrosilylation reaction catalyst may be a compound of such a metal, for example, chloridotris(triphenylphosphane)rhodium(I) (Wilkinson's Catalyst), a rhodium diphosphine chelate such as [1,2-bis(diphenylphosphino)ethane]dichlorodirhodium or [1,2-bis(diethylphospino)ethane]dichlorodirhodium, chloroplatinic acid (Speier's Catalyst), chloroplatinic acid hexahydrate, platinum dichloride, and complexes of said compounds with low molecular weight organopolysiloxanes or platinum compounds microencapsulated in a matrix or coreshell type structure. Complexes of platinum with low molecular weight organopolysiloxanes include 1,3-diethenyl-1,1,3,3-tetramethyldisiloxane complexes with platinum (Karstedt's Catalyst). These complexes may be microencapsulated in a resin matrix. Alternatively, a hydrosilylation reaction catalyst may comprise 1,3-diethenyl-1,1,3,3-tetramethyldisiloxane complex with platinum. Exemplary hydrosilylation reaction catalysts are described in U.S. Pat. Nos. 3,159,601; 3,220,972; 3,296,291; 3,419,593; 3,516,946; 3,814,730; 3,989,668; 4,784,879; 5,036,117; and 5,175,325; and EP 0 347 895 B. Microencapsulated hydrosilylation reaction catalysts and methods of preparing them are known in the art, as exemplified in U.S. Pat. Nos. 4,766,176 and 5,017,654. Hydrosilylation reaction catalysts are commercially available, for example, SYL-OFF™ 4000 Catalyst and SYL-OFF™ 2700 are available from Dow Silicones Corporation of Midland, Mich., USA.

The amount of hydrosilylation reaction catalyst used herein will depend on various factors including the selection of starting materials (A), (B), and (D) and their respective contents of silicon bonded hydrogen atoms and aliphatically unsaturated groups and the content of the platinum group metal in the catalyst selected as starting material (C), however, the amount of hydrosilylation reaction catalyst is sufficient to catalyze hydrosilylation reaction of SiH and aliphatically unsaturated groups, alternatively the amount of catalyst is sufficient to provide 1 ppm to 1000 ppm of the platinum group metal based on combined weights of starting materials (A), (B), and (C); alternatively 1 ppm to 150 ppm, on the same basis.

Alternatively, in the Si-PSA composition, the hydrosilylation reaction catalyst may comprise a platinum-organosiloxane complex. When a platinum organosiloxane complex is used as the hydrosilylation reaction catalyst, the hydrosilylation reaction catalyst may be present at 1.1 weight parts to 2.8 weight parts, per 100 weight parts of starting materials (A), (B), and (C) combined.

### (F) Anchorage Additive

The Si-PSA composition further comprises (F) an anchorage additive. Without wishing to be bound by theory, it is thought that the anchorage additive will facilitate bonding to a substrate by a Si-PSA prepared by curing the Si-PSA composition described herein.

Suitable anchorage additives include silane coupling agents such as methyltrimethoxysilane, vi nyltrimethoxysilane, allyltrimethoxysilane, 3-methacryloxypropyltrimethoxysilane, 3-aminopropyltrimethoxysilane, N-(2-aminoethyl)-3-aminopropyltrimethoxysilane, bis(trimethoxysilyl)propane, and bis(trimethoxysilylhexane; and mixtures or reaction mixtures of said silane coupling agents. Alternatively, the anchorage additive may be tetramethoxysilane, tetraethoxysilane, dimethyldimethoxysilane, methylphenyldimethoxysilane, methylphenyldiethoxysilane, phenyltrimethoxysilane, methyltrimethoxysilane, methyltriethoxysilane, vinyltriethoxysilane, allyltriethoxysilane, 3-glycidoxypropyltrimethoxysilane, 3-glycidoxypropyltriethoxysilane, or 3-methacryloxypropyl trimethoxysilane.

Alternatively, the anchorage additive may be exemplified by a reaction product of a vinyl alkoxysilane and an epoxy-functional alkoxysilane; a reaction product of a vinyl acetoxysilane and epoxy-functional alkoxysilane; and a combination (e.g., physical blend and/or a reaction product) of a polyorganosiloxane having at least one aliphatically unsaturated hydrocarbon group and at least one hydrolyzable group per molecule and an epoxy-functional alkoxysilane (e.g., a combination of a hydroxy-terminated, vinyl functional polydimethylsiloxane with glycidoxypropyltrimethoxysilane). Suitable anchorage additives and methods for their preparation are disclosed, for example, in U.S. Patent Application Publication Numbers 2003/0088042, 2004/0254274, and 2005/0038188; and EP 0 556 023.

Exemplary anchorage additives are known in the art, such as in U.S. Patent Publication 2012/0328863 at paragraph [0091] and U.S. Patent Publication 2017/0233612 at paragraph [0041]. Anchorage additives are commercially available. For example, SYL-OFF™ 297 is available from Dow Silicones Corporation of Midland, Mich., USA. Other exemplary anchorage additives include i) vinyltriacetoxysilane, ii) glycidoxypropyltrimethoxysilane, and iii) a combination of i) and ii). This combination iii) may be a physical blend and/or a reaction product.

The amount of anchorage additive depends on various factors including the type of substrate to which the Si-PSA will be applied. However, the amount of anchorage additive may be 0.5 weight parts to 2.5 weight parts, per 100 weight parts of starting materials (A), (B), and (C) combined.

### (G) Solvent

The Si-PSA composition further comprises (G) a solvent. Suitable solvents include organic liquids exemplified by, but not limited to, aromatic hydrocarbons, aliphatic hydrocarbons, alcohols, aldehydes, ketones, amines, esters, ethers, glycols, glycol ethers, alkyl halides and aromatic halides. Hydrocarbons include benzene, toluene, xylene, hexane, heptane, octane, isododecane, isohexadecane, Isopar L (C11-C13), Isopar H (C11-C12), hydrogenated polydecene. Suitable alcohols include, but are not limited to, methanol, ethanol, isopropanol, butanol, or n-propanol. Suitable ketones include, but are not limited to, acetone, methylethyl ketone, or methyl isobutyl ketone. Ethers and esters include, isodecyl neopentanoate, neopentylglycol heptanoate, glycol distearate, dicaprylyl carbonate, diethylhexyl carbonate, propylene glycol n-propyl ether, propylene glycol-n-butyl ether, ethyl-3 ethoxypropionate, propylene glycol methyl ether acetate, tridecyl neopentanoate, propylene glycol methylether acetate (PGMEA), propylene glycol methylether (PGME), dipropylene glycol methyl ether, or ethylene glycol n-butyl ether, octyldodecyl neopentanoate, diisobutyl adipate, diisopropyl adipate, propylene glycol dicaprylate/dicaprate, octyl ether, and octyl palmitate. Alternatively, the solvent may be selected from polyalkylsiloxanes, alcohols, ketones, glycol ethers, tetrahydrofuran, mineral spirits, naphtha, tetrahydrofuran, mineral spirits, naphtha, or a combination thereof. Polyalkylsiloxanes with suitable vapor pressures may be used as the solvent, and these include hexamethyldisiloxane, octamethyltrisiloxane, hexamethylcyclotrisiloxane, octamethylcyclotetrasiloxane, decamethylcyclopentasiloxane, dodecamethylcyclohexasiloxane, octamethyltrisiloxane, decamethyltetrasiloxane, dodecamethylpentasiloxane, tetradecamethylhexasiloxane, hexadecamethylheptasiloxane, heptamethyl-3-{(trimethylsilyl)oxy)}trisiloxane, hexamethyl-3,3, bisf(trimethylsilyl)oxyltrisiloxane pentamethyl{(trimethylsilyl)oxy}cyclotrisiloxane, and combinations thereof. Low molecular weight polyalkylsiloxanes, such as 0.5 to 1.5 cSt polydimethylsiloxanes are known in the art and commercially available as DOWSIL™ 200 Fluids and DOWSIL™ OS FLUIDS, which are commercially available from Dow Silicones Corporation. Alternatively, the solvent may be selected from the group consisting of toluene, xylene, heptane, ethyl acetate, and a combination of two or more thereof.

The amount of solvent will depend on various factors including the type of solvent selected and the amount and type of other starting materials selected. However, the amount of solvent may be 80 weight parts to 200 weight parts, based on combined weights of all starting materials in the Si-PSA composition. The solvent may be added during preparation of the Si-PSA composition, for example, to aid mixing and delivery. Certain starting materials may be delivered in solvent, such as the polyorganosilicate resin and/or the hydrosilylation reaction catalyst.

The Si-PSA composition may optionally further comprise one or more additional starting materials, such as (H) a hydrosilylation reaction inhibitor (inhibitor) that may optionally be used for altering rate of reaction of the silicon bonded hydrogen atoms of starting material (D) and the aliphatically unsaturated hydrocarbon groups of stating materials (A) and (B), as compared to reaction rate of the same starting materials but with the inhibitor omitted. Inhibitors are exemplified by acetylenic alcohols such as methyl butynol, ethynyl cyclohexanol, dimethyl hexynol, and 3,5-dimethyl-1-hexyn-3-ol, 1-butyn-3-ol, 1-propyn-3-ol, 2-methyl-3-butyn-2-ol, 3-methyl-1-butyn-3-ol, 3-methyl-1-pentyn-3-ol, 3-phenyl-1-butyn-3-ol, 4-ethyl-1-octyn-3-ol, 3,5-dimethyl-1-hexyn-3-ol, and 1-ethynyl-1-cyclohexanol, and a combination thereof; cycloalkenylsiloxanes such as methylvinylcyclosiloxanes exemplified by 1,3,5,7-tetramethyl-1,3,5,7-tetravinylcyclotetrasiloxane, 1,3,5,7-tetramethyl-1,3,5,7-tetrahexenylcyclotetrasiloxane, and a combination thereof; ene-yne compounds such as 3-methyl-3-penten-1-yne, 3,5-dimethyl-3-hexen-1-yne, and a combination thereof; triazoles such as benzotriazole; phosphines; mercaptans; hydrazines; amines, such as tetramethyl ethylenediamine, 3-dimethylamino-1-propyne, n-methylpropargylamine, propargylamine, and 1-ethynylcyclohexylamine; dialkyl fumarates such as diethyl fumarate, dialkenyl fumarates such as diallyl fumarate, dialkoxyalkyl fumarates, maleates such as diallyl maleate and diethyl maleate; nitriles; ethers; carbon monoxide; alkenes such as cyclo-octadiene, divinyltetramethyldisiloxane; alcohols such as benzyl alcohol; and a combination thereof.

Alternatively, the inhibitor may be a silylated acetylenic compound. Without wishing to be bound by theory, it is thought that adding a silylated acetylenic compound reduces yellowing of the reaction product prepared from hydrosilylation reaction as compared to a reaction product from hydrosilylation of starting materials that do not include a silylated acetylenic compound or that include an organic acetylenic alcohol inhibitor, such as those described above.

The silylated acetylenic compound is exemplified by (3-methyl-1-butyn-3-oxy)trimethylsilane, ((1,1-dimethyl-2-propynyl)oxy)trimethylsilane, bis(3-methyl-1-butyn-3-oxy)dimethylsilane, bis(3-methyl-1-butyn-3-oxy)silanemethylvinylsilane, bis((1,1-dimethyl-2-propynyl)oxy)dimethylsilane, methyl(tris(1,1-dimethyl-2-propynyloxy))silane, methyl(tris(3-methyl-1-butyn-3-oxy))silane, (3-methyl-1-butyn-3-oxy)dimethylphenylsilane, (3-methyl-1-butyn-3-oxy)dimethylhexenylsilane, (3-methyl-1-butyn-3-oxy)triethylsilane, bis(3-methyl-1-butyn-3-oxy)methyltrifluoropropylsilane, (3,5-dimethyl-1-hexyn-3-oxy)trimethylsilane, (3-phenyl-1-butyn-3-oxy)diphenylmethylsilane, (3-phenyl-1-butyn-3-oxy)dimethylphenylsilane, (3-phenyl-1-butyn-3-oxy)dimethylvinylsilane, (3-phenyl-1-butyn-3-oxy)dimethylhexenylsilane, (cyclohexyl-1-ethyn-1-oxy)dimethylhexenylsilane, (cyclohexyl-1-ethyn-1-oxy)dimethylvinylsilane, (cyclohexyl-1-ethyn-1-oxy)diphenylmethylsilane, (cyclohexyl-1-ethyn-1-oxy)trimethylsilane, and combinations thereof. Alternatively, the silylated acetylenic compound is exemplified by methyl(tris(1,1-dimethyl-2-propynyloxy))silane, ((1,1-dimethyl-2-propynyl)oxy)trimethylsilane, or a combination thereof. The silylated acetylenic compound useful as the inhibitor herein may be prepared by methods known in the art, for example, U.S. Pat. No. 6,677,740 discloses silylating an acetylenic alcohol described above by reacting it with a chlorosilane in the presence of an acid receptor.

The amount of inhibitor added herein will depend on various factors including the desired reaction rate, the particular inhibitor used, and the selection and amount of starting materials (A), (B), and (D). However, when present, the amount of inhibitor may range from >0% to 1%, alternatively >0% to 5%, alternatively 0.001% to 1%, alternatively 0.01% to 0.5%, alternatively 0.002% to 0.15%, and alternatively 0.0025% to 0.025%, based on the combined weights of all starting materials in the Si-PSA composition.

### Method of Making the Si-PSA Composition

The Si-PSA composition can be prepared by a method comprising combining all starting materials by any convenient means such as mixing at ambient or elevated temperature. The inhibitor may be added before the hydrosilylation reaction catalyst, for example, when the Si-PSA composition will be prepared at elevated temperature and/or the Si-PSA composition will be prepared as a one part composition.

The method may further comprise delivering one or more starting materials in the solvent (e.g., the polyorganosilicate resin and/or the hydrosilylation reaction catalyst) may be dissolved in a solvent when combined with one or more of the other starting materials in the Si-PSA composition, and thereafter all or substantially all of the solvent may be removed by conventional means such as stripping and/or distillation, optionally with reduced pressure).

Alternatively, the Si-PSA composition may be prepared as a multiple part composition, for example, when the Si-PSA composition will be stored for a long period of time before use, e.g., up to 6 hours before coating the Si-PSA composition on a substrate. In the multiple part composition, the hydrosilylation reaction catalyst is stored in a separate part from any starting material having a silicon bonded hydrogen atom, for example the polyorganohydrogensiloxane, and the parts are combined shortly before use of the Si-PSA composition.

For example, a multiple part Si-PSA composition may be prepared by combining starting materials comprising at least some of the polydiorganosiloxane polymer and/or the polydiorganosiloxane gum, the polyorganohydrogensiloxane, and optionally one or more other additional starting materials described above to form a base part, by any convenient means such as mixing. A curing agent may be prepared by combining starting materials comprising at least some of the polydiorganosiloxane polymer and/or the polydiorganosiloxane gum, the hydrosilylation reaction catalyst, and optionally one or more other additional starting materials described above by any convenient means such as mixing. The starting materials may be combined at ambient or elevated temperature. The inhibitor may be included in one or more of the base part, the curing agent part, or a separate additional part. The anchorage additive may be added to the base part, or may be added as a separate additional part. The polyorganosilicate resin may be added to the base part, the curing agent part, or a separate additional part. The polydiorganosiloxane gum may be added to the base part. When a two part Si-PSA composition is used, the weight ratio of amounts of base part to curing agent part may range from 1:1 to 10:1. The Si-PSA composition will cure via hydrosilylation reaction to form a Si-PSA.

The method described above may further comprise one or more additional steps. The Si-PSA composition prepared as described above may be used to form an adhesive article, e.g., a Si-PSA (prepared by curing the Si-PSA composition described above) on a substrate. The method may, therefore, further comprise comprises applying the Si-PSA composition to a substrate. Applying the Si-PSA composition to the substrate can be performed by any convenient means. For example, the Si-PSA composition may be applied onto a substrate by gravure coater, slot die, comma coater, offset coater, offset-gravure coater, roller coater, reverse-roller coater, air-knife coater, or curtain coater.

The substrate can be any material that can withstand the curing conditions (described below) used to cure the pressure sensitive adhesive composition to form the pressure sensitive adhesive on the substrate. For example, any substrate that can withstand heat treatment at a temperature equal to or greater than 120° C., alternatively 150° C. is suitable. Examples of materials suitable for such substrates including plastic films such as polyimide (PI), polyetheretherketone (PEEK), polyethylene naphthalate (PEN), liquid-crystal polyarylate, polyamideimide (PAI), polyether sulfide (PES), polyethylene terephthalate (PET), polyethylene (PE), polypropylene (PP), polycarbonate (PC), or thermoplastic polyurethane (TPU). Alternatively, the substrate may be selected from the group consisting of PET, TPU and PC. The thickness of the substrate may be 10 μm to 150 μm.

To improve bonding of the pressure sensitive adhesive to the substrate, the method for forming the adhesive article may optionally further comprise treating the substrate before applying the Si-PSA composition. Treating the substrate may be performed by any convenient means, such as applying a primer, or subjecting the substrate to corona-discharge treatment, etching, or plasma treatment before applying the Si-PSA composition to the substrate.

An adhesive article such as a protective film may be prepared by applying the Si-PSA composition described above onto the substrate described above. The method may optionally further comprise removing all, or a portion, of the solvent before and/or during curing. Removing solvent may be performed by any convenient means, such as heating at a temperature that vaporizes the solvent without fully curing the Si-PSA composition, e.g., heating at a temperature of 70° C. to 120° C., alternatively 50° C. to 100° C., and alternatively 70° C. to 80° C. for a time sufficient to remove all or a portion of the solvent (e.g., 30 seconds to 1 hour, alternatively 1 minute to 5 minutes).

Curing the Si-PSA composition may be performed by heating at a temperature of 80° C. to 200° C., alternatively 90° C. to 180° C., alternatively 100° C. to 160° C., and alternatively 110° C. to 150° C. for a time sufficient to cure the Si-PSA composition (e.g., for 30 seconds to an hour, alternatively 1 to 5 minutes). If cure speed needs to be increased or the process oven temperatures lowered, the catalyst level can be increased. Curing the Si-PSA composition forms a Si-PSA on the substrate. Curing may be performed by placing the substrate in an oven. The amount of the Si-PSA composition to be applied to the substrate depends on the specific application, however, the amount may be sufficient such that (after curing) thickness of the Si-PSA may be 5 μm to 100 μm, alternatively 5 μm to 50 μm, alternatively 6 μm to 50 μm, alternatively 8 μm to 45 μm.

The method described herein may optionally further comprise applying a removable release liner to the Si-PSA opposite the substrate, e.g., to protect the Si-PSA before use of the adhesive article. The release liner may be applied before, during or after curing the Si-PSA composition; alternatively after curing.

### Method of Use

The thickness of Si-PSA prepared as described above may be 5 μm to 100 μm, alternatively 5 μm to 50 μm, alternatively 6 μm to 50 μm, alternatively 8 μm to 45 μm; with the exact thickness depending on the design of the protective film. The protective film may have a single layer of a substrate or multiple layers with more than one substrate. Between multiple layers of substrates, the protective film may further comprise an acrylic PSA between different substrates. The thickness of each substrate may be 10 μm to 150 μm, alternatively 10 μm to 100 μm.

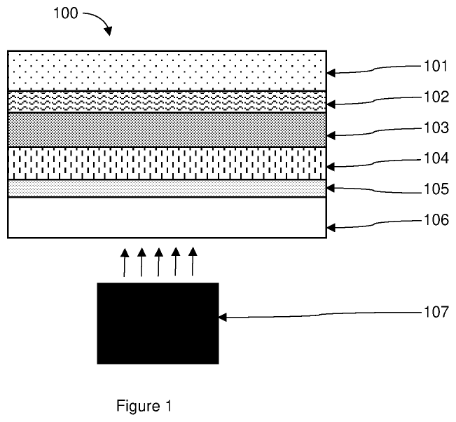

FIG. 1 shows a partial cross section of an exemplary protective film (100) for an ultrasonic fingerprint sensor. The protective film (100) comprises a first polymeric substrate (103) having a first surface opposite a second surface. The Si-PSA described above (104) is disposed on the first surface of the first polymeric substrate (103). The protective film (100) may further comprise an acrylic PSA (102) interposed between the second surface of the first polymeric substrate (103) and a first surface of a second polymeric substrate (101) opposite the second surface of the first substrate (103).

The acrylic PSA (102) and the second polymeric substrate (101) are optional. For example, in a protective film for a smartphone with 2D edge glass, the acrylic PSA (102) and the second substrate (101) may be eliminated such that the protective film (100) consists essentially of the first polymeric substrate (103) and the Si-PSA (104), described above.

An ultrasonic fingerprint sensor comprises an ultrasound source (107), a cover glass (106) overlying the ultrasound source (107), and the protective film (100) described above overlying a surface of the cover glass (106) opposite the ultrasound source (107). The Si-PSA (104) can contact the surface of the cover glass (106) opposite the ultrasound source (107). The cover glass (106) may have an anti-fingerprint coating (105) disposed on the surface of the cover glass (106), and the protective film (100) may be disposed on the surface of the anti-fingerprint coating (105) opposite the cover glass (106). The ultrasound source (107) is configured to send an ultrasonic wave through the cover glass (106), the anti-fingerprint coating (105) and the protective film (100) over which a person's finger (not shown) may be placed to obtain a fingerprint image. The protective film (100) is an ultrasonically transmissive medium.

### EXAMPLES

These examples are intended to illustrate the invention to one skilled in the art and are not to be interpreted as limiting the scope of the invention set forth in the claims. The starting materials in Table 1 were used in these examples.

TABLE 1

| Starting | | |
|---|---|---|
| Material | Description | Source |
| A-i) Gum | bis-vinyldimethylsiloxy terminated | Dow Silicones |
| | polydimethylsiloxane with Mn = 702,000 g/mol and | Corporation |
| | vinyl content = 0.012% | |
| B-i) Polymer | bis-vinyldimethylsiloxy terminated | SILASTIC ™ SFD-128 |
| | polydimethylsiloxane with DP = 800 to 1,000; Mn = | |
| | 62,000 g/mol; and vinyl content = 0.088% | |
| B-ii) Polymer | bis-vinyldimethylsiloxy terminated | SILASTIC ™ SFD-120 |
| | polydimethylsiloxane with DP = 600 to 700; Mn = | |
| | 35,000 g/mol; and vinyl content = 0.13% | |
| B-iii) Polymer | bis-vinyldimethylsiloxy terminated | SILASTIC ™ SFD-117 |
| | polydimethylsiloxane with Mn = 22,000 g/mol and | |
| | vinyl content = 0.22% | |
| B-iv) Polymer | bis-vinyldimethylsiloxy terminated | SILASTIC ™ SFD-119 |
| | polydimethylsiloxane with DP = 150; Mn = 11,500 | |
| | g/mol; and vinyl content = 0.45% | |
| B-v) Polymer | bis-vinyldimethylsiloxy terminated | mixture of SILASTIC ™ |
| | poly(dimethyl/methylhydrogen)siloxane with Mn of | SFD-903 and SFD-906 |
| | 80,000-90,000 g/mol and vinyl content 0.36% | |
| C-i) Resin | MQ resin having units of formula (Me₃SiO_{1/2}) and | Dow Silicones |
| (comparative) | (SiO_{4/2}) and Mn = 4,700 | Corporation |
| C-ii) Resin | MQ resin having units of formula (Me₃SiO_{1/2}) and | Dow Silicones |
| (comparative) | (SiO_{4/2}) and Mn = 4,100 | Corporation |
| C-iii) Resin | MQ resin having units of formula (Me₃SiO_{1/2}) and | Dow Silicones |
| | (SiO_{4/2}) and Mn = 2,700 | Corporation |
| C-iv) Resin | MQ resin having units of formula (Me₃SiO_{1/2}) and | Dow Silicones |
| | (SiO_{4/2}) and Mn = 2,900 | Corporation |
| D-i) XL | trimethylsiloxy-terminated | SYL-OFF ™ 7028 |
| | polymethylhydrogensiloxane with SiH content = 1.6% | |
| D-ii) XL | trimethylsiloxy-terminated poly(dimethyl, | DOWSIL ™ |
| | methylhydrogen)siloxane with SiH content = 0.76% | 6-3570 |
| E-i) Catalyst | Karstedt’s Catalyst | Dow Silicones |
| | | Corporation |
| F-i) Anchorage | reaction products of vinyltriacetoxysilane and | SYL-OFF ™ 297 |
| Additive | glycidoxypropyltrimethoxysilane | Additive |
| G-i) Solvent | mixture of toluene, xylene, ethylacetate, and heptane | Millipore Sigma of St. |
| | | Louis, Missouri, USA |

DOWSIL™, SILASTIC™, and SYL-OFF™ products are commercially available form Dow Silicones Corporation of Midland, Mich., USA.

### Reference Example A

### Preparation of Si-PSA Compositions

Samples of Si-PSA compositions were prepared by combining the starting materials in the amounts shown below in Tables 2, 3, and 4. All the starting materials were mixed at room temperature. The starting materials (A) and (C) were dissolved in (G) the solvent under mixing until the resulting mixture was homogenous. Then the starting material (B) was thoroughly blended into the mixture above. And then the starting material (D) was thoroughly blended into the mixture. And then the starting material (F) anchorage additive was thoroughly blended into the mixture. Finally, starting material (E) catalyst was added and mixed until homogeneous.

### Reference Example B

### Adhesion Test Method

A sample of an Si-PSA prepared according to Reference Example A was coated on 50 μm PET. The resulting coated film was cured in an oven for 2 min at 140° C. The thickness of the resulting cured Si-PSA on PET film was 25 μm to 30 μm. Adhesion was measured by laminating the sample as described above (25 μm to 30 μm Si-PSA+50 μm PET) onto a substrate, either glass with AF coating or standard stainless steel, using 2 kg roller (twice—forward and back). The water contact angle of glass with AF coating was 115° tested by a contact angle tester. A peel test was performed by peeling the sample from the substrate at an angle of 180° and a rate of 0.3 m/min using an adhesion tester, i.e., Cheminstruments adhesion/release tester model AR1500. The results are shown below in Tables 2, 3, and 4.

### Reference Example C

### Rheological Data Test Method

Cured Si-PSA films each having a thickness of 0.5 mm-1.5 mm were prepared for rheological properties testing on a rheometer, either TA DHR-2 or ARES-G2. Loss modulus G″ and storage modulus G′ at different temperatures (i.e., from 200° C. to −80° C.) were measured by a temperature ramp program with oscillation mode at a cooling rate of 3° C./min under 1 Hz. Tan delta was calculated by G″/G′. The glass transition temperature was defined as the temperature at peak point of tan delta.

TABLE 2
Comparative Examples - Amounts of Starting Materials are in Weight Parts

| Starting Material | Comp-1 | Comp-2 | Comp-3 | Comp-4 | Comp-5 | Comp-6 | Comp-7 | Comp-8 |
|---|---|---|---|---|---|---|---|---|
| A-i) Gum | 33.78 | 17.98 | 21.57 | 34.81 | 24.82 | 19.68 | 20.45 | 20.45 |
| B-i) Polymer | 0 | 0 | 0 | 0 | 0 | 0 | 13.99 | 0 |
| B-ii) Polymer | 0 | 0 | 0 | 0 | 0 | 0 | 0 | 13.99 |
| B-v) Polymer | 0 | 12.30 | 20.66 | 0 | 12.22 | 13.46 | 0 | 0 |
| C-i) Resin | 0 | 0 | 0 | 61.71 | 0 | 0 | 0 | 0 |
| (comparative) | | | | | | | | |
| C-ii) Resin | 0 | 0 | 0 | 0 | 61.11 | 0 | 0 | 0 |
| (comparative) | | | | | | | | |
| C-iv) Resin | 66.21 | 69.71 | 57.77 | 3.48 | 1.85 | 66.85 | 65.56 | 65.56 |
| G-i) Solvent | Some | Some | Some | Some | Some | Some | Some | Some |
| D-i) XL | 0 | 0.80 | 0 | 0.15 | 0.7142 | 0 | 0 | 0 |
| D-ii) XL | 0.46 | 0.24 | 2.65 | 0 | 0 | 2.29 | 0.98 | 1.54 |
| F-i) Anchorage | 0.50 | 0.50 | 0.51 | 0.50 | 0.50 | 0.70 | 0.68 | 0.68 |
| Additive | | | | | | | | |
| E-i) Catalyst | 2.08 | 1.90 | 2.28 | 2.37 | 2.29 | 2.32 | 2.30 | 2.31 |
| (B)/(A) Weight | 0.00 | 0.68 | 0.96 | 0.00 | 0.49 | 0.68 | 0.68 | 0.68 |
| Ratio | | | | | | | | |
| (C)/(B + A) Weight | 1.96 | 2.30 | 1.37 | 1.87 | 1.70 | 2.02 | 1.90 | 1.90 |
| Ratio | | | | | | | | |
| SiH/Vi Mole Ratio | 23.17 | 10.79 | 7.47 | 22.81 | 8.46 | 9.74 | 13.57 | 15.27 |
| Adhesion on SUS | 1100.0 | 911.5 | 168.8 | 1189.0 | 1159.8 | 869.0 | 732.4 | 638.7 |
| (g/inch) | | | | | | | | |
| Adhesion on AF | 38.3 | 6.80 | 6.30 | <5 | 0.4 | 15.7 | 24.1 | 20.2 |
| glass (g/inch) | | | | | | | | |
| Tg (° C.) | 2.62 | 23.77 | −10.30 | 64.00 | 64.00 | 8.55 | −7.01 | −2.36 |
| tan delta peak | 1.80 | 1.33 | 0.78 | 1.28 | 0.89 | 1.27 | 1.70 | 1.62 |
| G′ at −60° C. (Pa) | 3.2E+07 | 6.7E+07 | 2.0E+07 | 5.65E+07 | 4.90E+07 | 3.30E+07 | 1.82E+07 | 2.11E+07 |
| G′ at 25° C. (Pa) | 2.9E+04 | 2.7E+05 | 1.3E+05 | 2.74E+05 | 2.65E+06 | 7.73E+04 | 2.14E+04 | 2.75E+04 |
| G′ at 60° C. (Pa) | 1.6E+04 | 5.6E+04 | 1.1E+05 | 2.04E+05 | 4.26E+05 | 3.35E+04 | 1.70E+04 | 2.00E+04 |
| Tan delta @ 25° C. | 1.05 | 1.32 | 0.55 | 0.76 | 0.61 | 1.02 | 0.58 | 0.68 |
| Tan delta @ 60° C. | 0.41 | 0.61 | 0.14 | 1.28 | 0.89 | 0.30 | 0.15 | 0.15 |

TABLE 3
Working Examples

| Starting Material | Ex-1 | Ex-2 | Ex-3 | Ex-4 | Ex-5 | Ex-6 | Ex-7 | Ex-8 |
|---|---|---|---|---|---|---|---|---|
| A-i) Gum | 21.73 | 20.65 | 21.73 | 19.90 | 19.90 | 19.15 | 17.64 | 17.64 |
| B-iii) Polymer | 0 | 0 | 0 | 0 | 0 | 0 | 0 | 0 |
| B-iv) Polymer | 0 | 0 | 0 | 0 | 0 | 0 | 0 | 0 |
| B-v) Polymer | 14.87 | 14.13 | 14.87 | 16.71 | 16.71 | 16.08 | 19.17 | 19.17 |
| C-iii) Resin | 0 | 0 | 0 | 0 | 0 | 0 | 0 | 0 |
| C-iv) Resin | 63.40 | 65.21 | 63.40 | 63.38 | 63.38 | 64.76 | 63.20 | 63.20 |
| G-i) Solvent | Some | Some | Some | Some | Some | Some | Some | Some |
| D-i) XL | 0.80 | 0 | 0 | 0.95 | 0.5 | 0.95 | 1.22 | 0.65 |
| D-ii) XL | 0.29 | 2.54 | 2.67 | 0.27 | 0.27 | 0.26 | 0 | 0.24 |
| F-i) Anchorage | 0.51 | 0.51 | 0.51 | 0.51 | 0.50 | 0.51 | 0.51 | 0.50 |
| Additive | | | | | | | | |
| E-i) Catalyst | 2.28 | 2.28 | 2.28 | 2.28 | 2.28 | 2.28 | 2.27 | 2.27 |
| (B)/(A) Weight | 0.68 | 0.68 | 0.68 | 0.84 | 0.84 | 0.84 | 1.09 | 1.09 |
| Ratio | | | | | | | | |
| (C)/(B + A) | 1.73 | 1.87 | 1.73 | 1.73 | 1.73 | 1.84 | 1.72 | 1.72 |
| Weight Ratio | | | | | | | | |
| SIH/Vi Mole | 10.79 | 10.31 | 10.31 | 10.58 | 6.01 | 10.58 | 10.00 | 6.05 |
| Ratio | | | | | | | | |
| Adhesion on | 496.3 | 583.0 | 498.1 | 442.0 | 609.5 | 674.2 | 515.5 | 525.4 |
| SUS (g/inch) | | | | | | | | |
| Adhesion on AF | 20.40 | 23.93 | 18.77 | 15.80 | 17.53 | 20.07 | 16.27 | 17.00 |
| glass (g/inch) | | | | | | | | |
| Tg (° C.) | −5.70 | 0.97 | −5.50 | −6.98 | −2.75 | 3.49 | −1.41 | −4.70 |
| tan delta peak | 1.30 | 1.36 | 1.31 | 1.10 | 1.20 | 1.18 | 1.12 | 1.10 |
| G′ at −60° C. (Pa) | 2.7E+07 | 3.9E+07 | 2.7E+07 | 2.0E+07 | 2.6E+07 | 3.3E+07 | 3.5E+07 | 2.6E+07 |
| G′ at 25° C. (Pa) | 5.9E+04 | 7.4E+04 | 5.5E+04 | 6.6E+04 | 7.0E+04 | 1.1E+05 | 1.1E+05 | 8.1E+04 |
| G′ at 60° C. (Pa) | 4.1E+04 | 4.5E+04 | 4.9E+05 | 4.5E+04 | 4.5E+04 | 5.6E+04 | 6.7E+04 | 5.3E+04 |
| Tan delta @ | 0.59 | 0.79 | 0.67 | 0.53 | 0.65 | 0.83 | 0.66 | 0.60 |
| 25° C. | | | | | | | | |
| Tan delta @ | 0.13 | 0.19 | 0.16 | 0.16 | 0.17 | 0.24 | 0.17 | 0.16 |
| 60° C. | | | | | | | | |

TABLE 4
Additional Working Examples

| Starting Material | Ex-9 | Ex-10 | Ex-11 | Ex-12 | Ex-13 | Ex-14 | Ex-15 | Ex-16 |
|---|---|---|---|---|---|---|---|---|
| A-i) Gum | 20.53 | 18.79 | 16.95 | 20.65 | 20.45 | 17.03 | 14.79 | 20.37 |
| B-iii) Polymer | 0 | 0 | 0 | 0 | 13.99 | 0 | 0 | 0 |
| B-iv) Polymer | 0 | 0 | 0 | 0 | 0 | 0 | 0 | 13.94 |
| B-v) Polymer | 14.05 | 15.77 | 18.41 | 14.13 | 0 | 18.50 | 22.76 | 0 |
| C-iii) Resin | 25.17 | 28.61 | 31.43 | 0 | 0 | 0 | 0 | 0 |
| C-iv) Resin | 40.25 | 36.83 | 33.22 | 65.21 | 65.56 | 64.47 | 62.45 | 65.31 |
| G-i) Solvent | Some | Some | Some | Some | Some | Some | Some | Some |
| D-i) XL | 0.8 | 0.96 | 1.22 | 0 | 0 | 1.22 | 0 | 0 |
| D-ii) XL | 0.28 | 0.25 | 0.23 | 1.69 | 3.64 | 0.23 | 1.57 | 2.37 |
| F-i) Anchorage Additive | 0.51 | 0.51 | 0.51 | 0.51 | 0.68 | 0.51 | 0.74 | 0.68 |
| E-i) Catalyst | 2.28 | 2.28 | 2.27 | 2.28 | 2.36 | 2.27 | 2.30 | 2.32 |
| (B)/(A) Weight Ratio | 0.68 | 0.84 | 1.09 | 0.68 | 0.68 | 1.09 | 1.54 | 0.68 |
| (C)/(B + A) Weight Ratio | 1.89 | 1.89 | 1.83 | 1.87 | 1.90 | 1.81 | 1.66 | 1.90 |
| SIH/Vi Mole Ratio | 10.79 | 10.68 | 10.73 | 6.87 | 11.40 | 10.73 | 4.05 | 14.67 |
| Adhesion on SUS | 500.2 | 431.0 | 360.6 | 620.1 | 556.1 | 609.2 | 396.7 | 488.6 |
| (g/inch) | | | | | | | | |
| Adhesion on AF | 26.1 | 17.0 | 15.17 | 17.5 | 17.9 | 14.47 | 10.6 | 14.4 |
| glass (g/inch) | | | | | | | | |
| Tg (° C.) | 8.57 | 8.84 | 11.02 | 0.21 | −2.96 | 4.06 | −12.07 | −3.56 |
| tan delta peak | 1.21 | 1.15 | 1.10 | 1.34 | 1.48 | 1.09 | 1.08 | 1.33 |
| G′ at −60° C. (Pa) | 5.8E+07 | 5.2E+07 | 6.3E+07 | 2.6E+07 | 3.11E+07 | 3.7E+07 | 1.16E+07 | 2.19E+07 |
| G′ at 25° C. (Pa) | 9.6E+04 | 9.7E+04 | 1.3E+05 | 5.3E+04 | 4.68E+04 | 1.2E+05 | 4.02E+04 | 4.38E+04 |
| G′ at 60° C. (Pa) | 4.2E+04 | 4.1E+04 | 5.0E+04 | 3.4E+04 | 3.20E+04 | 6.2E+04 | 3.04E+04 | 3.03E+04 |
| Tan delta @ 25° C. | 0.87 | 0.86 | 0.87 | 0.74 | 0.70 | 0.78 | 0.45 | 0.65 |
| Tan delta @ 60° C. | 0.24 | 0.23 | 0.24 | 0.18 | 0.16 | 0.23 | 0.12 | 0.15 |

The comparative examples in Table 2 showed that when a polyorganosilicate resin with Mn>4,000 g/mol was used (in Comp 4 and Comp 5), adhesion on stainless steel was >800 g/inch, adhesion on an anti-fingerprint coating on glass was <10 g/inch, and Tg was >20, each of which properties are undesirable for some applications. Furthermore, when Polymer/Gum (B)/(A) ratio was <0.4 (in Comp 1 with no B) polymer), adhesion on stainless steel was >800 g/inch. When Resin/Polymer (C)/(B+A) ratio was >2.0 (in Comp 2 and Comp 6), adhesion on stainless steel was >800 g/inch and tan delta properties were also negatively impacted, suggesting that appropriate (C)/(B+A) ratio may contribute to improved rheological properties resulting in improved ultrasound transmission properties, which are desirable for use in an ultrasonic fingerprint sensor. Comp 3 showed that when (C)/(B+A) was i<1.4, adhesion to anti-fingerprint coating on glass was <10 g/inch, and rheological properties (tan delta peak) were too low for some applications. Comp 7 and Comp 8 showed that when vinyl content of the B) Polymer was ≤0.13%, modulus was too low at some temperatures.

In contrast, working examples 1 to 16 in Tables 3 and 4 show that a Si-PSA can be prepared with an adhesion on anti-fingerprint coating on glass>10 g/inch, an adhesion on stainless steel<800 g/inch, a Tg<20° C., a tan delta peak>1.0, a G′ at −60° C. of >1.0×10⁷ Pa; a G′ at 25° C. of >3.0×10⁴ Pa; and a G′ at 60° C. of >2.0×10⁴ Pa, a tan delta at 25° C.<0.9, and a tan delta at 60° C.<0.4.

At a (C)/(B+A) ratio in the range 1.80-1.90 and when vinyl content of starting material (B)>0.13%, working examples 2, 6, 9, 10, 11, 12, 13, 14, 16 can be compared with Comp 4. These working examples each contained a polyorganosilicate resin with Mn<4000 g/mol and showed that a Si-PSA could be prepared with an adhesion on anti-fingerprint coating on glass>10 g/inch, an adhesion on stainless steel<800 g/inch, a Tg<20° C., and a tan delta at 60° C.<0.4. In contrast, Comp 4 contained a polyorganosilicate resin with Mn>4000 g/mol, and the Si-PSA prepared therewith had an adhesion on anti-fingerprint coating on glass<10 g/inch, an adhesion on stainless steel>800 g/inch, Tg>20° C. and a tan delta at 60° C.>0.4. Without wishing to be bound by theory, it is thought that these working examples and comparative example showed that Mn of the polyorganosilicate resin<4,000 g/mol contributes to the desired combination of properties for the Si-PSA.

At a (C)/(B+A) ratio in the range 1.80-1.90 and when Mn of starting material (C)<4000 g/mol, working examples 2, 6, 9, 10, 11, 12, 13, 14, 16 can be compared with Comps 7 and 8. These working examples each contained a polymer with vinyl content>1.3% and showed that a Si-PSA could be prepared with a G′ at 25° C. of >3.0×10⁴ Pa; and a G′ at 60° C. of >2.0×10⁴ Pa. In contrast, Comps 7 and 8 contained a polymer with vinyl content≤1.3%, and the Si-PSA prepared therewith had a G′ at 25° C. of <3.0×10⁴ Pa; and a G′ at 60° C. of <2.0×10⁴ Pa. Without wishing to be bound by theory, it is thought that these working examples and comparative examples showed that vinyl content of starting material (B)>0.13% contributes to the desired combination of properties for the Si-PSA.

At a (C)/(B+A) ratio in the range 1.70-1.73, working examples 1, 3, 4, 5, 7, 8 can be compared with Comp 5. These working examples each contained a polyorganosilicate resin with Mn<4000 g/mol and showed that a Si-PSA could be prepared with an adhesion on anti-fingerprint coating on glass>10 g/inch, an adhesion on stainless steel<800 g/inch, a Tg<20° C., a tan delta peak>1.0, and a tan delta at 60° C.<0.4. In contrast, Comp 5 contained a polyorganosilicate resin with Mn>4000 g/mol, and the Si-PSA prepared therewith had an adhesion on anti-fingerprint coating on glass<10 g/inch, an adhesion on stainless steel>800 g/inch, a Tg>20° C., a tan delta peak<1.0, and a tan delta at 60° C.>0.4. Without wishing to be bound by theory, it is thought that these working examples and comparative example showed that Mn of the polyorganosilicate resin<4,000 g/mol contributes to the desired combination of properties for the Si-PSA.

At a (C)/(B+A) ratio of 1.89-1.90 and a (B)/(A) ratio at 0.68, working examples 9, 13 and 16 can be compared with Comp 7 and Comp 8. These working examples showed that when vinyl content of the (B) Polymer was >0.13%, a Si-PSA could be prepared with storage modulus G′ at 25° C.>3.0×10⁴ Pa and G′ at 60° C.>2.0×10⁴ Pa. In contrast, Comp 7 and Comp 8 showed that when vinyl content of the (B) Polymer was ≤0.13%, the Si-PSA prepared therewith had storage modulus G′ at 25° C.<3.0×10⁴ Pa and G′ at 60° C.<2.0×10⁴ Pa. Without wishing to be bound by theory, it is thought that vinyl content of (B) the polydiorganosiloxane polymer impacts rheological properties of the Si-PSA prepared therewith, and vinyl content>0.13% improves modulus properties.

At a fixed (B)/(A) ratio as 0.68 and when vinyl content of starting material (B)>0.13%, working examples 1,2,3,9,12,13,16 with (C)/(B+A) ratio<2.0 showed that a Si-PSA can be prepared with an adhesion on anti-fingerprint coating on glass>10 g/inch, an adhesion on stainless steel<800 g/inch, a Tg<20° C., a tan delta at 25° C.<0.9 and a tan delta at 60° C.<0.4. In contrast, at a fixed (B)/(A) ratio as 0.68 and vinyl content of starting material (B)>0.13%, comps 2 and 6 with (C)/(B+A) ratio>2.0 showed that a Si-PSA can be prepared with either an adhesion on anti-fingerprint coating on glass<10 g/inch, and/or an adhesion on stainless steel>800 g/inch, and/or a Tg>20° C., and a tan delta at 25° C.>0.9, and/or a tan delta at 60° C.>0.4.

At a (B)/(A) ratio range of 0.95 to 1.1, working examples 7, 8, 11, and 14 can be compared with Comp 3. These working examples had (C)/(B+A) ratio>1.4 and showed that a Si-PSA could be prepared with an adhesion on anti-fingerprint coating on glass>10 g/inch, and a tan delta peak>1.0. In contrast, Comp 3 had (C)/(B+A) ratio<1.4, and the Si-PSA prepared therewith had an adhesion on anti-fingerprint coating on glass<10 g/inch, and a tan delta peak<1.0. Without wishing to be bound by theory, it is thought that (C)/(B+A) ratio can contribute to adhesion on anti-fingerprint coating on glass.

Working examples 1-16 showed that the samples with (B)/(A) ratio>0.4 each produced a Si-PSA with an adhesion on stainless steel<800 g/inch a G′ at 25° C. of >3.0×10⁴ Pa; and a G′ at 60° C. of >2.0×10⁴ Pa, a tan delta at 25° C.<0.9, and a tan delta at 60° C.<0.4. In contrast, Comp 1 had a (B)/(A) ratio<0.4 and produced a Si-PSA with an adhesion on stainless steel>800 g/inch a G′ at 25° C. of <3.0×10⁴ Pa; and a G′ at 60° C. of <2.0×10⁴ Pa, a tan delta at 25° C.>0.9, and a tan delta at 60° C.>0.4. Without wishing to be bound by theory it is thought that Si-PSA compositions with a (B)/(A) ratio≥0.4 may provide the benefit of good adhesion to stainless steel and good modulus properties.

Working example 15 showed that a Si-PSA composition with a relatively high (B)/(A) ratio (1.54) produced a Si-PSA with an adhesion on anti-fingerprint coating on glass>10 g/inch, an adhesion on stainless steel<800 g/inch, a Tg<20° C., a tan delta peak>1.0, a G′ at −60° C. of >1.0×10⁷ Pa, a G′ at 25° C. of >3.0×10⁴ Pa; and a G′ at 60° C. of >2.0×10⁴ Pa, a tan delta at 25° C.<0.9, and a tan delta at 60° C.<0.4.

### Problem to be Solved

Screen protective films used in previously known optical fingerprint sensors may not be suitable for use in display devices with ultrasonic fingerprint sensors because the ultrasonic transfer mechanism in the protective film is different than that of the optical fingerprint identification technology. Therefore, there is an industry need for a pressure sensitive adhesive that can be used in a protective film for an ultrasonic fingerprint sensor.

### INDUSTRIAL APPLICABILITY

A pressure sensitive adhesive desirably has an adhesion on anti-fingerprint coating on glass>10 grams/inch, alternatively >14 grams/inch, alternatively 10 g/inch to 27 g/inch. Without wishing to be bound by theory, it is thought that lower adhesion to an AF coating on glass (e.g., <10 g/inch) may cause lifting or even delamination from AF coating on glass during processing, or in use of an ultrasonic fingerprint sensor including the pressure sensitive adhesive as part of a protective film for said sensor, for example when the protective film is used for a fingerprint sensor in a smartphone or other electronic device with 2.5D or 3D edge glass.

The pressure sensitive adhesive desirably has an adhesion on stainless steel<800 grams/inch, alternatively <700 grams/inch, alternatively 395 g/inch to <800 g/inch, alternatively 400 g/inch to <700 g/inch, and alternatively 430 g/inch to 675 g/inch. Without wishing to be bound by theory, it is thought that higher adhesion on stainless steel (e.g., ≥800 g/inch) may contribute to problems with die-cutting.

The pressure sensitive adhesive desirably has a low Tg of <20° C. Without wishing to be bound by theory, it is thought that low Tg will facilitate use of the adhesive at lower temperatures, e.g., winter months. Low Tg may also ensure that the Si-PSA has good elasticity and flexibility at room temperature.

The pressure sensitive adhesive described herein desirably has a high tan delta peak of >1.0. Without wishing to be bound by theory, it is thought that increasing the value of tan delta peak contributes to the Si-PSA having good wetting on surfaces, which improves adhesion to anti-fingerprint coatings on glass substrates.

The pressure sensitive adhesive desirably has high G′ values, e.g., a G′ at −60° C. of >1.0×10⁷ Pa; a G′ at 25° C. of >3.0×10⁴ Pa; and a G′ at 60° C. of >2.0×10⁴ Pa. Without wishing to be bound by theory, it is thought that sound speed through materials with the above high G′ values will be higher than sound speed through materials with lower G′ values, and high sound speed transmission through the Si-PSA is desirable for ultrasonic fingerprint sensor applications.

The pressure sensitive adhesive desirably has low tan delta, e.g., a tan delta at 25° C.<0.9, and a tan delta at 60° C.<0.4. Without wishing to be bound by theory, is thought that an Si-PSA having low tan delta values described above will exhibit less sound damping and better performance in a protective film for an ultrasonic fingerprint sensor, as compared to an Si-PSA that has a higher tan delta value than that described above.

Without wishing to be bound by theory, it is thought that this combination of properties (an adhesion on anti-fingerprint coating on glass>10 g/inch, an adhesion on stainless steel<800 g/inch, a Tg<20° C., a tan delta peak>1.0, a G′ at −60° C. of >1.0×10⁷ Pa; a G′ at 25° C. of >3.0×10⁴ Pa; and a G′ at 60° C. of >2.0×10⁴ Pa, a tan delta at 25° C.<0.9, and a tan delta at 60° C.<0.4) renders a pressure sensitive adhesive, such as the Si-PSA prepared by curing the Si-PSA composition described herein, suitable for use in a protective film for an ultrasonic fingerprint sensor. A pressure sensitive adhesive having the combination of properties described herein is suitable for use in a protective film for an ultrasonic fingerprint sensor in various display devices such as mobile telephones, mobile television receivers, wireless devices, smartphones, personal data assistants, wireless electronic mail receivers, hand-held or portable computers, netbooks, notebooks, smartbooks, tablets, global positioning system receivers/navigators, cameras, digital media players, camcorders, game consoles, and electronic reading devices. Alternatively, a pressure sensitive adhesive having the properties described herein may be used in addition to, or instead of, any pressure sensitive adhesive in a display device disclosed, for example, in U.S. Patent Publication Nos. 2019/0033494 and US2018/0373913 and Chinese Patent Publication No. CN109522885A.

### Definitions and Usage of Terms

All amounts, ratios, and percentages herein are by weight, unless otherwise indicated. The SUMMARY and ABSTRACT are hereby incorporated by reference. The terms “comprising” or “comprise” are used herein in their broadest sense to mean and encompass the notions of “including,” “include,” “consist(ing) essentially of,” and “consist(ing) of. The use of “for example,” “e.g.,” “such as,” and “including” to list illustrative examples does not limit to only the listed examples. Thus, “for example” or “such as” means “for example, but not limited to” or “such as, but not limited to” and encompasses other similar or equivalent examples. The abbreviations used herein have the definitions in Table 5.

TABLE 5
Abbreviations

| Abbreviation | Definition |
|---|---|
| AF | anti-fingerprint |
| DP | degree of polymerization |
| g | Grams |
| G′ | shear modulus |
| G″ | loss modulus |
| GPC | gel permeation chromatography |
| Hz | Hertz |
| kg | Kilogram |
| m | Meters |
| Me | Methyl |
| min | minutes |
| mm | millimeters |
| Mn | number average molecular weight |
| | measured by GPC as disclosed in U.S. Patent |
| | 9,593,209, Reference Example 1 at col. 31. |
| NMR | nuclear magnetic resonance |
| PET | polyethylene terephthalate |
| Ph | Phenyl |
| PSA | pressure sensitive adhesive, including but |
| | not limited to acrylic, rubber, and/or |
| | silicone pressure sensitive adhesives |
| Si-PSA | silicone pressure sensitive adhesive |
| tan delta | ratio of loss modulus to storage modulus |
| Tg | glass transition temperature measured |
| | according to Reference Example C |
| μm | micrometers |
| Vi | Vinyl |

The invention has been described in an illustrative manner, and it is to be understood that the terminology which has been used is intended to be in the nature of words of description rather than of limitation. With respect to any Markush groups relied upon herein for describing particular features or aspects, different, special, and/or unexpected results may be obtained from each member of the respective Markush group independent from all other Markush members. Each member of a Markush group may be relied upon individually and or in combination and provides adequate support for specific embodiments within the scope of the appended claims.

Furthermore, any ranges and subranges relied upon in describing the present invention independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present invention, and such ranges and subranges may be further delineated into relevant halves, thirds, quarters, fifths, and so on. As just one example, a range of “1 to 30” may be further delineated into a lower third, i.e., 1 to 10, a middle third, i.e., 11 to 20, and an upper third, i.e., from 21 to 30, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit.

### Embodiments of the Invention

In a first embodiment, a protective film for an ultrasonic fingerprint sensor is disclosed, where the protective film comprises:
1) a pressure sensitive adhesive having an adhesion on anti-fingerprint coating on glass>10 g/inch, an adhesion on stainless steel<800 g/inch, a Tg<20° C., a tan delta peak>1.0, a G′ at −60° C. of >1.0×10⁷ Pa; a G′ at 25° C. of >3.0×10⁴ Pa; and a G′ at 60° C. of >2.0×10⁴ Pa, a tan delta at 25° C.<0.9, and a tan delta at 60° C.<0.4;
2) a first polymeric substrate having a first surface and an opposing second surface, where the pressure sensitive adhesive is disposed on the first surface,
optionally 3) an acrylic pressure sensitive adhesive disposed on the second surface of the first polymeric substrate, and
optionally 4) a second polymeric substrate overlying the acrylic pressure sensitive adhesive opposite the second surface of the first polymeric substrate.

In a second embodiment, in the protective film of the first embodiment, the first polymeric substrate comprises a plastic selected from the group consisting of PET, TPU, and PC.

In a third embodiment, in the protective film of the first embodiment or the second embodiment, the pressure sensitive adhesive has a thickness of 5 μm to 100 μm, alternatively 5 μm to 50 μm, alternatively 6 μm to 50 μm, and alternatively 8 μm to 45 μm.

In a fourth embodiment, in the protective film of any one of the first to third embodiments, the first polymeric substrate has a thickness of 10 μm to 150 μm, alternatively 10 μm to 100 μm.

In a fifth embodiment, in the protective film of any one of the first to fourth embodiments, the second polymeric substrate is selected from the group consisting of PET and PC.

In a sixth embodiment, in the protective film of any one of the first to fifth embodiments, the second polymeric substrate has a thickness of 10 μm to 150 μm, alternatively 10 μm to 100 μm.

In a seventh embodiment, in the protective film of any one of the first to sixth embodiments, the acrylic pressure sensitive adhesive has a thickness of 5 μm to 100 μm, alternatively 5 μm to 50 μm, alternatively 6 μm to 50 μm, and alternatively 8 μm to 45 μm.

In an eighth embodiment, in the protective film of the of any one of the first to seventh embodiments, the pressure sensitive adhesive is a silicone pressure sensitive adhesive prepared by curing a silicone pressure sensitive adhesive composition comprising:

(A) a polydiorganosiloxane gum having a number average molecular weight≥500,000 g/mol, where the polydiorganosiloxane gum is terminated with an aliphatically unsaturated group;

(B) a polydiorganosiloxane polymer having a number average molecular weight≤100,000 g/mol and an aliphatically unsaturated group content of >0.13 weight %;

where starting materials (A) and (B) are present in a weight ratio (B)/(A) of 0.4 to 1.6;

(C) a polyorganosilicate resin having a number average molecular weight<4,000 g/mol, where starting materials (A), (B) and (C) are present in a weight ratio (C)/(B+A) of 1.4 to 2;

(D) a polyorganohydrogensiloxane;

where starting materials (A), (B), and (D) are present in amounts sufficient to provide a molar ratio of silicon bonded hydrogen atoms/silicon bonded aliphatically unsaturated groups (SiH/Vi ratio) of 4 to 30 in the composition;

(E) a hydrosilylation reaction catalyst;

(F) an anchorage additive;

(G) a solvent; and

Optionally (H) a hydrosilylation reaction inhibitor.

In a ninth embodiment, in the protective film of the eighth embodiment, starting material (A) the polydiorganosiloxane gum has unit formula (A-1): (R^{M}₂R^{U}SiO_{1/2})₂(R^{M}₂SiO_{2/2})ₐ, where each R^{M} is an independently selected monovalent hydrocarbon group of 1 to 30 carbon atoms that is free of aliphatic unsaturation; each R^{U} is an independently selected monovalent aliphatically unsaturated hydrocarbon group of 2 to 30 carbon atoms; and subscript a has a value sufficient to give the polydiorganosiloxane gum a number average molecular weight of 500,000 g/mol to 1,000,000 g/mol.

In a tenth embodiment, in the protective film of one of the eighth or ninth embodiments, starting material (A) the polydiorganosiloxane gum is present at 14 weight parts to 22 weight parts, per 100 weight parts of starting materials (A), (B), and (C)

In an eleventh embodiment, in the protective film of any one of the eighth to tenth embodiments, starting material (B) the polydiorganosiloxane polymer has unit formula (B-1): (R^{M}₃SiO_{1/2})_{b}(R^{M}₂R^{U}SiO_{1/2})_{c}(R^{M}₂SiO_{2/2})_{d}(R^{M}R^{U}SiO_{2/2})ₑ, where each R^{M} is an independently selected monovalent hydrocarbon group of 1 to 30 carbon atoms that is free of aliphatic unsaturation; each R^{U} is an independently selected monovalent aliphatically unsaturated hydrocarbon group of 2 to 30 carbon atoms; subscript b is 0, 1, or 2; subscript c is 0, 1, or 2, with the proviso that a quantity (b+c)=2; subscript d>0, subscript e≥0, with the proviso that a quantity (b+c+d+e) has a value sufficient to give the polydiorganosiloxane polymer a number average molecular weight of 10,000 to 75,000 g/mol.

In a twelfth embodiment, in the protective film of any one of the eighth to eleventh embodiments, starting material (B) the polydiorganosiloxane polymer is present at 13 weight parts to 23 weight parts, per 100 weight parts of starting materials (A), (B), and (C) combined.

In a thirteenth embodiment, in the protective film of any one of the eighth to twelfth embodiments, starting material (C) the polyorganosilicate resin comprises unit formula (C-1): (R^{M}₃SiO_{1/2})ₘ(R^{M}₂R^{U}SiO_{1/2})ₙ(SiO_{4/2})ₒ, where each R^{M} is an independently selected monovalent hydrocarbon group of 1 to 30 carbon atoms that is free of aliphatic unsaturation; each R^{U} is an independently selected monovalent aliphatically unsaturated hydrocarbon group of 2 to 30 carbon atoms; and subscripts m, n and o have values such that m>0, n≥0, o>1, with the proviso that a quantity (m+n+o) has a value sufficient to provide the polyorganosilicate resin with a number average molecular weight of 2,500 g/mol to <4,000 g/mol (alternatively 2700 g/mol to 2900 g/mol).

In a fourteenth embodiment, in the protective film of any one of the eighth to thirteenth embodiments, starting material (C) the polyorganosilicate resin is present at 60 weight parts to 66 weight parts, per 100 weight parts of starting materials (A), (B), and (C) combined.

In a fifteenth embodiment, in the protective film of any one of the eighth to fourteenth embodiments, starting material (D) the polyorganohydrogensiloxane has unit formula (D-1): (R^{M}₃SiO_{1/2})ᵣ(R^{M}₂HSiO_{1/2})ₛ(R^{M}₂SiO_{2/2})ₜ(R^{M}HSiO_{2/2})ᵤ, where each R^{M} is an independently selected monovalent hydrocarbon group of 1 to 30 carbon atoms that is free of aliphatic unsaturation; subscript r is 0, 1, or 2; subscript s is 0, 1, or 2, with the proviso that a quantity (r+s)=2; subscript t≥0, subscript u>0, with the proviso that a quantity (s+u)>2;

In a sixteenth embodiment, in the protective film of any one of the eighth to fifteenth embodiments, (D) the polyorganohydrogensiloxane is present at 0.7 weight parts to 3 weight parts, per 100 weight parts of starting materials (A), (B), and (C) combined.

In a seventeenth embodiment, in the protective film of any one of the eighth to sixteenth embodiments, where starting material (E) the hydrosilylation reaction catalyst comprises a platinum-organosiloxane complex.

In an eighteenth embodiment, in the protective film of any one of the eighth to seventeenth embodiments, (E) the hydrosilylation reaction catalyst is present at 1.1 weight parts to 2.8 weight parts, per 100 weight parts of starting materials (A), (B), and (C) combined.

In a nineteenth embodiment, an ultrasonic fingerprint sensor comprises:
A) an ultrasound source,
B) a cover glass overlying the ultrasound source, where the cover glass has a surface opposite the ultrasound source,
C) an anti-fingerprint coating on the surface of the cover glass, and
D) the protective film of any one of the preceding embodiments having the pressure sensitive adhesive 1) disposed on the anti-fingerprint coating.

1. A silicone pressure sensitive adhesive composition comprising:
(A) a polydiorganosiloxane gum having a number average molecular weight≥500,000 g/mol, where the polydiorganosiloxane gum is terminated with an aliphatically unsaturated group;
(B) a polydiorganosiloxane polymer having a number average molecular weight≤100,000 g/mol and an aliphatically unsaturated group content of >0.13 weight %; where starting materials (A) and (B) are present in a weight ratio (B)/(A) of 0.4 to 1.6;
(C) a polyorganosilicate resin having a number average molecular weight<4,000 g/mol,
where starting materials (A), (B) and (C) are present in a weight ratio (C)/(B+A) of 1.4 to 2;
(D) a polyorganohydrogensiloxane;
where starting materials (A), (B), and (D) are present in amounts sufficient to provide a molar ratio of silicon bonded hydrogen atoms/silicon bonded aliphatically unsaturated groups (SiH/Vi ratio) of 4 to 30 in the composition;
(E) a hydrosilylation reaction catalyst;
(F) an anchorage additive; and
(G) a solvent.

2. The composition of claim 1, where starting material (A) the polydiorganosiloxane gum has unit formula (A-1): (R^{M}₂R^{U}SiO_{1/2})₂(R^{M}₂SiO_{2/2})ₐ, where each R^{M} is an independently selected monovalent hydrocarbon group of 1 to 30 carbon atoms that is free of aliphatic unsaturation; each R^{U} is an independently selected monovalent aliphatically unsaturated hydrocarbon group of 2 to 30 carbon atoms; and subscript a has a value sufficient to give the polydiorganosiloxane gum a number average molecular weight of 500,000 g/mol to 1,000,000 g/mol.

3. The composition of claim 1, where starting material (B) the polydiorganosiloxane polymer has unit formula (B-1): (R^{M}₃SiO_{1/2})_{b}(R^{M}₂R^{U}SiO_{1/2})_{c}(R^{M}₂SiO_{2/2})_{d}(R^{M}R^{U}SiO_{2/2})ₑ, where each R^{M} is an independently selected monovalent hydrocarbon group of 1 to 30 carbon atoms that is free of aliphatic unsaturation; each R^{U} is an independently selected monovalent aliphatically unsaturated hydrocarbon group of 2 to 30 carbon atoms; subscript b is 0, 1, or 2; subscript c is 0, 1, or 2, with the proviso that a quantity (b+c)=2; subscript d>0, subscript e≥0, with the proviso that a quantity (b+c+d+e) has a value sufficient to give the polydiorganosiloxane polymer a number average molecular weight of 10,000 to 75,000 g/mol.

4. The composition of claim 1, where starting material (C) the polyorganosilicate resin comprises unit formula (C-1): (R^{M}₃SiO_{1/2})ₘ(R^{M}₂R^{U}SiO_{1/2})ₙ(SiO_{4/2})ₒ, where each R^{M} is an independently selected monovalent hydrocarbon group of 1 to 30 carbon atoms that is free of aliphatic unsaturation; each R^{U} is an independently selected monovalent aliphatically unsaturated hydrocarbon group of 2 to 30 carbon atoms; and subscripts m, n and o have values such that m>0, n≥0, o>1, with the proviso that a quantity (m+n+o) has a value sufficient to provide the polyorganosilicate resin with a number average molecular weight of 2,500 to <4,000 g/mol.

5. The composition of claim 1, where starting material (D) the polyorganohydrogensiloxane has unit formula (D-1): (R^{M}₃SiO_{1/2})ᵣ(R^{M}₂HSiO_{1/2})ₛ(R^{M}₂SiO_{2/2})ₜ(R^{M}HSiO_{2/2})ᵤ, where each R^{M} is an independently selected monovalent hydrocarbon group of 1 to 30 carbon atoms that is free of aliphatic unsaturation; subscript r is 0, 1, or 2; subscripts is 0, 1, or 2, with the proviso that a quantity (r+s)=2; subscript t≥0, subscript u>0, with the proviso that a quantity (s+u)>2.

6. The composition of claim 1, where starting material (E) the hydrosilylation reaction catalyst comprises a platinum-organosiloxane complex.

7. The composition of claim 1, where starting material (F) the anchorage additive is selected from the group consisting of i) vinyltriacetoxysilane, ii) glycidoxypropyltrimethoxysilane, and iii) a combination of i) and ii), which combination may be a physical blend and/or a reaction product.

8. The composition of claim 1, where starting material (G) the solvent is selected from the group consisting of toluene, xylene, heptane, ethyl acetate, and a combination of two or more thereof.

9. A silicone pressure sensitive adhesive prepared by curing the composition of claim 1.

10. A protective film comprising:
1) the silicone pressure sensitive adhesive of claim 9,
2) a first polymeric substrate having a first surface and an opposing second surface, where the silicone pressure sensitive adhesive is disposed on the first surface,
optionally 3) an acrylic pressure sensitive adhesive disposed on the second surface of the first polymeric substrate, and
optionally 4) a second polymeric substrate overlying the acrylic pressure sensitive adhesive opposite the second surface of the first polymeric substrate.

11. A protective film comprising:
1) a silicone pressure sensitive adhesive having an adhesion on anti-fingerprint coating on glass>10 grams/inch, an adhesion on stainless steel<800 grams/inch, a glass transition temperature<20° C., a tan delta peak>1.0, a G′ at −60° C. of >1.0×10⁷ Pa, a G′ at 25° C. of >3.0×10⁴ Pa; a G′ at 60° C. of >2.0×10⁴ Pa; a tan delta at 25° C.<0.9; and a tan delta at 60° C.<0.4;
2) a first polymeric substrate having a first surface and an opposing second surface, where the pressure sensitive adhesive is disposed on the first surface,
optionally 3) an acrylic pressure sensitive adhesive disposed on the second surface of the first polymeric substrate, and
optionally 4) a second polymeric substrate overlying the acrylic pressure sensitive adhesive opposite the second surface of the first polymeric substrate.

12. The protective film of claim 10, where the first polymeric substrate comprises a plastic selected from the group consisting of polyethylene terephthalate, thermoplastic polyurethane, and polycarbonate.

13. The protective film of claim 10, where the second polymeric substrate is selected from the group consisting polyethylene terephthalate and polycarbonate.

14. An ultrasonic fingerprint sensor comprising:
A) an ultrasound source,
B) a cover glass overlying the ultrasound source,
C) an anti-fingerprint coating disposed on a surface of the cover glass opposite the ultrasound source, and
D) the protective film of claim 10, where the pressure sensitive adhesive is disposed on the anti-fingerprint coating opposite the cover glass.
